(19) United States
(12) Patent Application Publication
(10) Pub. No.: US 2021/0276167 A1
(43) Pub. Date: Sep. 9, 2021

(54) VACUUM NOZZLE ASSEMBLY FOR VACUUM-ASSISTED DRIVER

(71) Applicant: TTM TECHNOLOGIES, INC., Santa Ana, CA (US)

(72) Inventor: John O'Connor, Santa Ana, CA (US)

(21) Appl. No.: 17/191,480

(22) Filed: Mar. 3, 2021

Related U.S. Application Data
(60) Provisional application No. 62/985,233, filed on Mar. 4, 2020.

(51) Int. Cl. B25B 23/08; B25B 23/00; B25B 21/00

(52) U.S. Cl. CPC B25B 23/08; B25B 21/00; B25B 23/0035

(57) ABSTRACT

An assembly device may include a driver base. The assembly device may also include a driver bit having a main body between a base end and a tip end configured to drive a screw and the main body extending along a longitudinal axis, the driver bit configured to attach to the driver base. The assembly device may also include a vacuum adaptor comprising a forward end, a backward end, and an outer shell enclosing a hollow portion and extending along the longitudinal axis, the backward end configured to attach to the driver base. The assembly device may further include a vacuum nozzle comprising a side wall enclosing a cavity extending along the longitudinal axis from a forward open end to a backward open end opposite to the forward open end. The vacuum nozzle is coaxial with the driver bit and the vacuum adaptor. The backward open end is configured to attach to the forward end of the vacuum adaptor.

### CROSS-REFERENCE TO RELATED PATENT APPLICATIONS

This patent application claims the benefit under 35 U.S.C. § 119(e) of U.S. Patent Application Ser. No. 62/985,233, entitled “Vacuum Nozzle Assembly for Vacuum-Assisted Driver,” filed on Mar. 4, 2020, which is incorporated herein by reference in its entirety.

### FIELD

The disclosure is directed to a vacuum nozzle assembly for a driver or a driver bit using a vacuum system.

### BACKGROUND

A problem with the driver using a vacuum is that washers and/or lock washers would not be held onto screws with sufficient vacuum. There remains a need to develop a solution to solve the problem.

### BRIEF SUMMARY

In one aspect, a vacuum nozzle may include a side wall enclosing a cavity extending along a longitudinal axis from a first open end to a second open end opposite to the first open end. The vacuum nozzle may also include a plurality of interior grooves extending from an inner surface of the side wall into the side wall toward an outer surface of the side wall, the plurality of interior grooves extending along the longitudinal axis.

In another aspect, a vacuum nozzle assembly is provided. The vacuum nozzle assembly may include a driver bit having a main body between a base end and a tip end configured to drive a screw, and the main body extending along a longitudinal axis. The vacuum nozzle assembly may also include a vacuum adaptor comprising a forward end, a backward end, and an outer shell enclosing a hollow portion and extending along the longitudinal axis. The vacuum nozzle assembly may also include a vacuum nozzle comprising a side wall enclosing a cavity extending along the longitudinal axis from a forward open end to a backward open end opposite to the forward open end. The vacuum nozzle is coaxial with the driver bit and the vacuum adaptor. The backward open end is configured to attach to the forward end of the vacuum adaptor.

In a further aspect, an assembly device may include a driver base. The assembly device may also include a driver bit having a main body between a base end and a tip end configured to drive a screw and the main body extending along a longitudinal axis, the driver bit configured to attach to the driver base. The assembly device may also include a vacuum adaptor comprising a forward end, a backward end, and an outer shell enclosing a hollow portion and extending along the longitudinal axis, the backward end configured to attach to the driver base. The assembly device may further include a vacuum nozzle comprising a side wall enclosing a cavity extending along the longitudinal axis from a forward open end to a backward open end opposite to the forward open end. The vacuum nozzle is coaxial with the driver bit and the vacuum adaptor. The backward open end is configured to attach to the forward end of the vacuum adaptor.

In a further aspect, a method of using the assembly device is provided for holding screws and additional hardware including washers and/or lock washers. The vacuum nozzle enhances airflow to the vacuum source around the screws and helps provide sufficient vacuum to simultaneously hold the additional hardware including washers and/or lock washers with the screws.

Additional embodiments and features are set forth in part in the description that follows, and will become apparent to those skilled in the art upon examination of the specification, or may be learned by the practice of the disclosed subject matter. A further understanding of the nature and advantages of the disclosure may be realized by reference to the remaining portions of the specification and the drawings, which form a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1A illustrates a vacuum nozzle assembly including a vacuum adaptor and a vacuum nozzle with a driver bit exposed above the vacuum nozzle in according to embodiments of the disclosure.

FIG. 1B illustrates the vacuum nozzle assembly of FIG. 1A with the vacuum nozzle covering the driver bit in according to embodiments of the disclosure.

FIG. 2 illustrates operations of adjusting a torque nut and tightening a side screw in according to embodiments of the disclosure.

FIG. 3 illustrates operations of loading a driver bit into a driver base in according to embodiments of the disclosure.

FIG. 4 illustrates operations of loading the vacuum adaptor to a driver base in according to embodiments of the disclosure.

FIG. 5 illustrates operations of attaching the vacuum nozzle to the vacuum adaptor in according to embodiments of the disclosure.

FIG. 6A illustrates the operation of loosening a lock screw on a vacuum adaptor in according to embodiments of the disclosure.

FIG. 6B illustrates the proper operation of adjusting height of the vacuum nozzle to cover the driver bit in according to embodiments of the disclosure.

FIG. 6C illustrates the improper operation of adjusting height of the vacuum nozzle to expose the driver bit in according to embodiments of the disclosure.

FIG. 7 illustrates operations of ensuring the driver bit is properly aligned within the vacuum nozzle in according to embodiments of the disclosure.

FIG. 8 illustrates operations of connecting the vacuum adaptor to a main vacuum line in according to embodiments of the disclosure.

FIG. 9A illustrates a perspective view of the vacuum nozzle from one end in according to embodiments of the disclosure.

FIG. 9B illustrates a perspective view of the vacuum nozzle from another end in according to embodiments of the disclosure.

FIG. 9C illustrates a cross-sectional view of the vacuum nozzle in according to embodiments of the disclosure.

FIG. 10 illustrates an operation of disconnecting the vacuum adaptor from the main vacuum line in according to embodiments of the disclosure; and

FIG. 11 illustrates an operation of removing the vacuum nozzle from the vacuum adaptor in according to embodiments of the disclosure.

### DETAILED DESCRIPTION

The disclosure may be understood by reference to the following detailed description, taken in conjunction with the drawings as described below. It is noted that, for purposes of illustrative clarity, certain elements in various drawings may not be drawn to scale.

The disclosure provides a vacuum nozzle assembly which includes a vacuum adaptor, a driver bit, and a vacuum nozzle. The driver bit can extend through the vacuum nozzle and the vacuum adaptor to attach to a driver base. The vacuum nozzle is attached to the vacuum adaptor, which is attached to the driver base.

The vacuum nozzle assembly is designed to enhance airflow around screws and to provide sufficient vacuum to hold both the screws and additional hardware including washers, and/or lock washers, among others. For example, a vacuum is established within the vacuum nozzle during operation of driving a screw into a workpiece, and can be used to suck screws or fasteners while simultaneously holding washers and/or lock washers. The screws or fasteners may include plastic screws, aluminum screws, or stainless steel screws, and any other screws that are not magnetic.

The vacuum nozzle is designed to help enhance airflow in the vacuum nozzle assembly and provides sufficient vacuum for holding both the screw and the additional hardware. A conventional vacuum assembly without the vacuum nozzle could not provide sufficient vacuum for holding both the fastener and additional hardware, such as washers and/or lock washers.

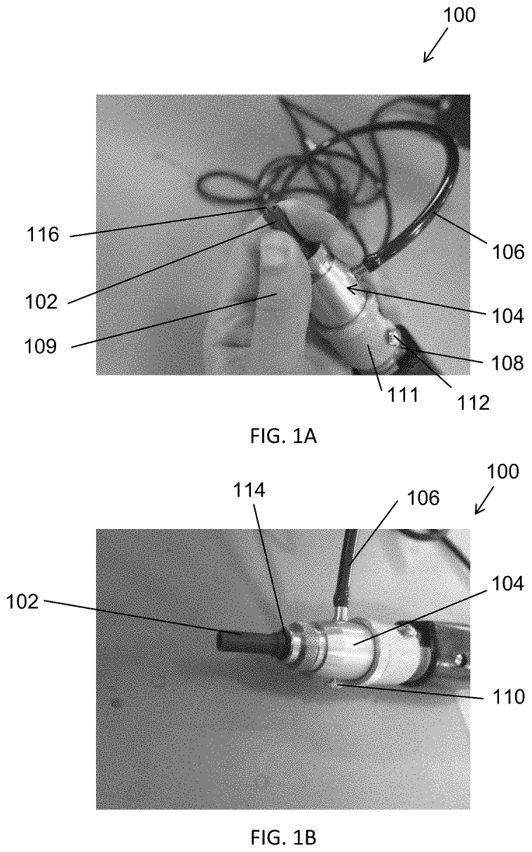

FIG. 1A illustrates a vacuum nozzle assembly including a vacuum adaptor and a vacuum nozzle with a driver bit exposed above the vacuum nozzle in according to embodiments of the disclosure. FIG. 1B illustrates the vacuum nozzle assembly of FIG. 1A with the vacuum nozzle covering the driver bit in according to embodiments of the disclosure.

A vacuum nozzle assembly 100 includes a vacuum nozzle 102, a driver bit 116, and a vacuum adaptor 104. The vacuum nozzle 102 is attached to the vacuum adaptor 104. The vacuum nozzle 102 can enhance airflow and help with providing sufficient vacuum to hold screws and washers and/or lock washers.

The vacuum adaptor 104 includes a connection to a vacuum line 106, which is coupled to a vacuum source. The vacuum adaptor 104 also includes a lock screw 110 that can fix the position of the vacuum nozzle 102 to the vacuum adaptor 104. The vacuum nozzle assembly 100 may also optionally include a seal ring 114 between the vacuum adaptor 104 and the vacuum nozzle 102. As shown, a vacuum nozzle 102 is pushed down with finger 109 such that a tip end of a driver bit 116 is exposed from an end of the vacuum nozzle 102.

An assembly device 200 may include the nozzle assembly 100, a driver base 108, and a torque nut 111. The driver base 108 is configured to hold the driver bit 116 and the vacuum adaptor 104. The driver base 108 may include a base portion 113, which includes a bit collect configured to hold the driver bit and also outer threads configured to connect to the vacuum adaptor 104.

The torque nut 111 is configured to allow a backward end of the vacuum adaptor 104 to fit inside and to attach the backward end of the vacuum adaptor. The torque nut 111 is also configured to be attached onto the base portion 113.

The driver base 108 may also include a side screw 112, which can fix the position of the torque nut 111 to the base portion 113, where the driver bit 116 extends through the torque nut 111, then the vacuum adaptor 104, and the vacuum nozzle 102.

In some variations, the vacuum nozzle is coaxial with the driver bit.

In some variations, the vacuum nozzle is coaxial with the vacuum adaptor.

In some variations, the seal ring may be formed of a rubber or an elastomer.

In some variations, screws or fasteners and additional hardware (e.g. washers and/or lock washers) can be held by vacuum using the vacuum nozzle assembly including the driver bit. It will be appreciated by those skilled in the art that the fasteners may be driven by a mechanical drill or the driver bit.

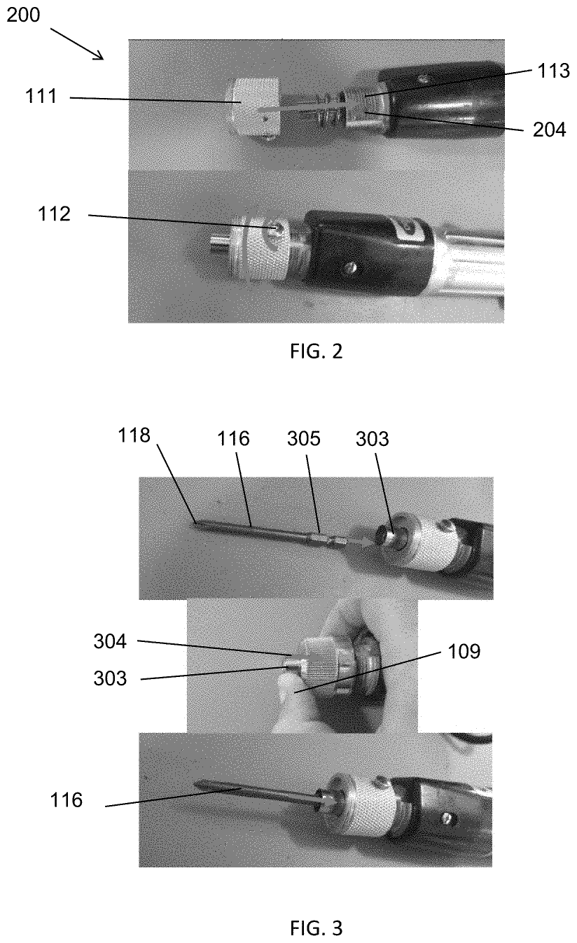

FIG. 2 illustrates operations of adjusting a torque nut and tightening a side screw in according to embodiments of the disclosure. As shown in FIG. 2, the torque nut 111 can be rotated to adjust its position on threads 204 of the base portion 113 and tightened by using the side screw 112.

FIG. 3 illustrates operations of loading a driver bit into a driver base in according to embodiments of the disclosure. As shown in FIG. 3, the driver bit 116 slides into an end portion or a bit collect 303 of the driver base 108. To do so, the end portion or bit collect 303 is pushed down by finger 109 against the base portion 113 as pointed by arrow 304 to open up, and then an end portion 305 of the driver bit 116 is inserted into the bit collect 303 of the base portion 113. When finger 109 is released, a driver bit 116 is mounted into the bit collect 303 of the base portion 113. The driver bit 116 is a vacuum-assisted screwdriver. The driver base 108 may be adapted to an electric power source to drive the driver bit 116 with an electric power.

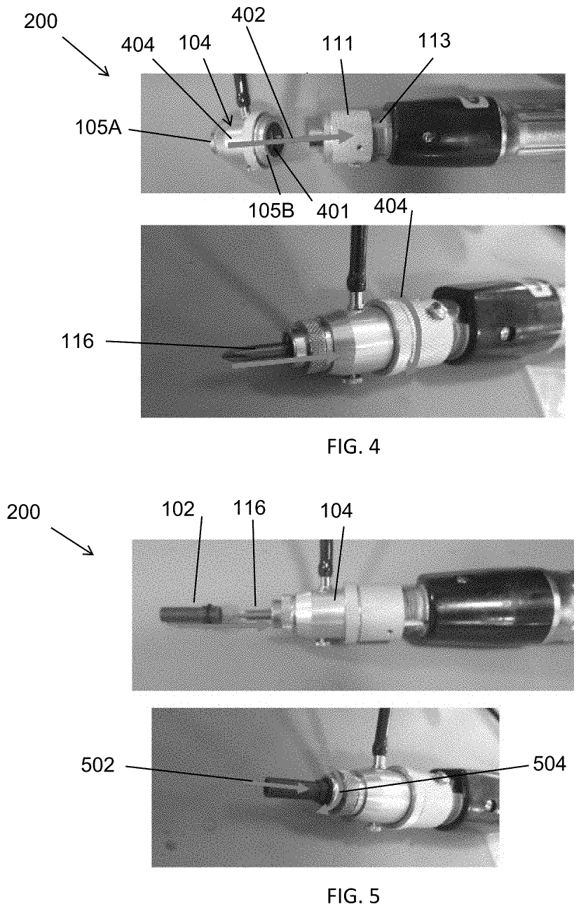

FIG. 4 illustrates operations of loading the vacuum adaptor to a driver base in according to embodiments of the disclosure. As shown in FIG. 4, the vacuum adaptor 104 slides over the driver bit 116, as pointed by an arrow 402, and then the vacuum adaptor 104 is rotated to attach to the driver base 108, as pointed by an arrow 404. The vacuum adaptor 104 includes a forward end 105A configured to connect to the vacuum nozzle 102, and a backward end 105B configured to attach to the base portion 113 of the driver base 108. The vacuum adaptor 104 includes an outer shell 404 enclosing a hollow portion 401 and extending along a longitudinal axis along the direction as pointed by arrow 402. The hollow portion is configured to allow the driver bit 116 and the vacuum nozzle 104 to extend through from the driver base 108.

FIG. 5 illustrates operations of attaching the vacuum nozzle to the vacuum adaptor in according to embodiments of the disclosure. As shown in FIG. 5, the vacuum nozzle 102 slides over the driver bit 116, as pointed by an arrow 502, and then the vacuum nozzle 102 is rotated to attach to the vacuum adaptor 104, as pointed by an arrow 504.

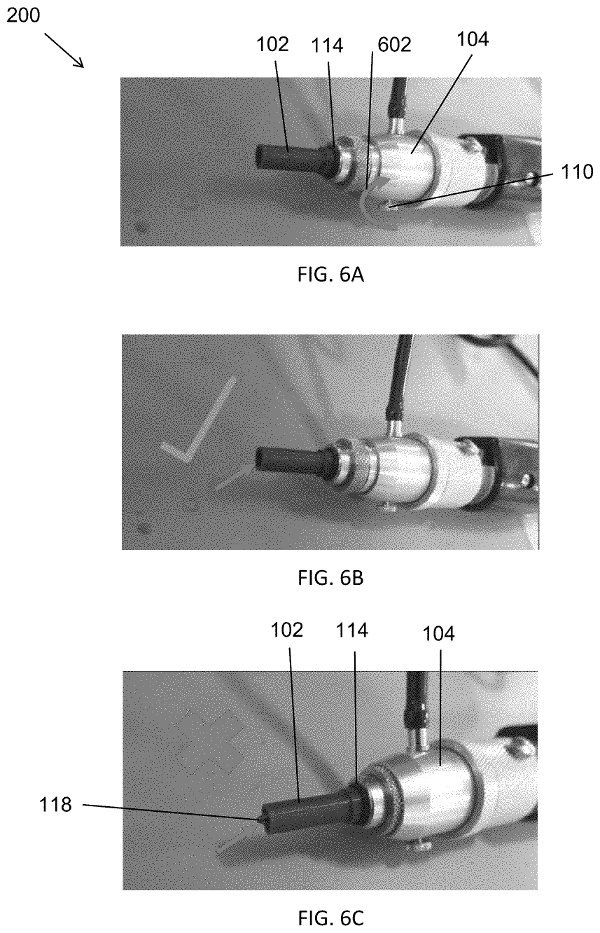

FIGS. 6A-C illustrate operations of adjusting height of the vacuum nozzle to cover the driver bit in according to embodiments of the disclosure. As shown in FIG. 6A, the height of the vacuum nozzle 102 can be adjusted by loosening the lock screw 110 on the vacuum adaptor 104 as pointed by arrow 602. The forward end 105A of the vacuum adaptor 104 is attached to a backward open end of the vacuum nozzle 102. The forward end 105A of the vacuum adaptor can be moved relative to the outer shell 404 of the vacuum adaptor. The lock screw 110 is used to fix the position of the forward end 105A along the longitudinal axis of the vacuum adaptor 104 relative to the outer shell 404. As shown in FIG. 6B, when the vacuum nozzle 102 covers the driver bit 116, the height of the vacuum nozzle 102 is considered to be good or acceptable. As shown in FIG. 6C, when a tip end 118 of the driver bit 116 extends to be exposed outside an end of the vacuum nozzle 102, the height of the vacuum nozzle 102 is considered to be not acceptable.

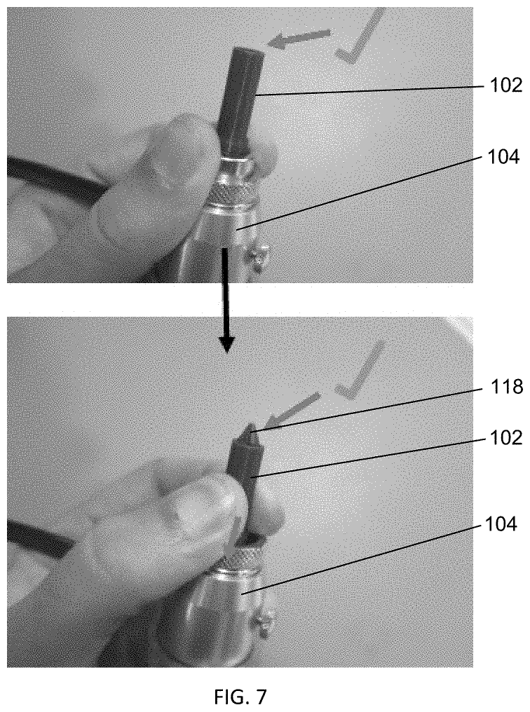

FIG. 7 illustrates operations of ensuring the driver bit is properly aligned within the vacuum nozzle in according to embodiments of the disclosure. As shown in FIG. 7, the vacuum nozzle 102 is pulled down with respect to the driver bit 116 to expose the tip end 118 of the driver bit 116, which can help ensure that the driver bit 116 is properly aligned with the vacuum nozzle 102.

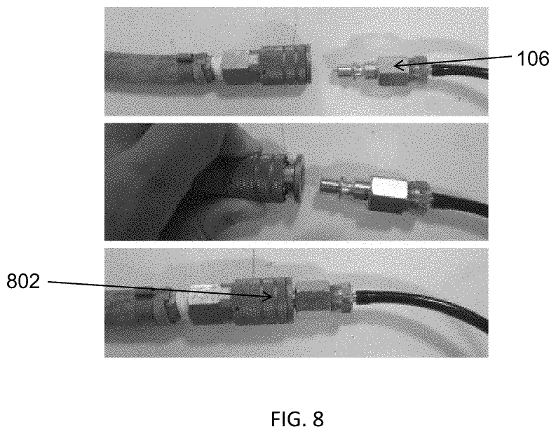

FIG. 8 illustrates operations of connecting the vacuum adaptor to a main vacuum line in according to embodiments of the disclosure. As shown in FIG. 8, the vacuum line 106 of the vacuum adaptor 104 connects to a main vacuum line 802, which is configured to connect to a vacuum source.

It will be appreciated by those skilled in the art that the driver bit varies in types. For example, the tip ends of the driver bit may vary.

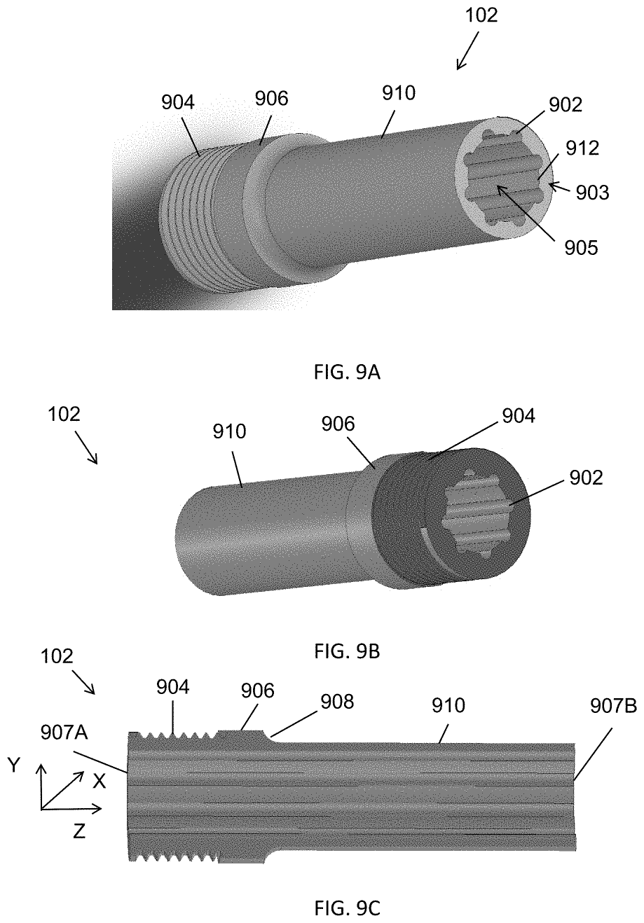

FIG. 9A illustrates a perspective view of the vacuum nozzle from one end in according to embodiments of the disclosure. FIG. 9B illustrates a perspective view of the vacuum nozzle from another end in according to embodiments of the disclosure. FIG. 9C illustrates a cross-sectional view of the vacuum nozzle in according to embodiments of the disclosure. As shown in FIGS. 9A-C, the vacuum nozzle 102 includes a plurality of interior grooves 902, which can enhance the airflow and provide enough vacuum such that screws as well as washers and/or lock washers can be held with sufficient vacuum. The vacuum nozzle 102 is also configured to attach to the vacuum adaptor 104 and to allow the driver bit 116 to extend therethrough. The vacuum nozzle 102 may have an exterior of a substantially cylindrical shape.

The vacuum nozzle 102 includes a side wall 903 enclosing a cavity 905. The side wall 903 extends along a longitudinal axis Z from a backward open end 907A to a forward open end 907B opposite to the backward open end 907A, which is configured to attach to the forward end of the vacuum adaptor 104. The backward open end 907A is in a fluidic communication with the vacuum line 106 of the vacuum adaptor 104.

The cavity 905 of the vacuum nozzle 102 is configured to allow the driver bit 116 to extend from the backward open end 907A through the forward open end 907B. The side wall 903 includes an unthreaded outer wall surface 910 having a first diameter and an inner wall surface 912 having a second diameter.

The vacuum nozzle 102 includes a plurality of interior grooves 902 on the inner wall surface 912 of the side wall, the grooves 902 extending from the inner wall surface 912 of the side wall into the side wall toward the outer wall surface 910. The grooves 902 have a depth less than the difference between the first and second diameters. The grooves 902 may have a cross-section in a half circle shape, as shown. The plurality of grooves 902 extend along the longitudinal axis Z of the vacuum nozzle 102 and spaced apart circumferentially on a cross-section in X-Y plane perpendicular to the longitudinal axis Z.

As shown in FIG. 9C, the side wall 903 of the vacuum nozzle 102 may include the first unthreaded portion 910. The side wall 903 may also include a threaded portion with exterior threads or outer threads 904 near the backward open end 907A. The outer threads 904 of the vacuum nozzle 102 are configured to screw into inner threads of the vacuum adaptor 104 near the forward end 105A. The inner threads of the vacuum adaptor are not shown. FIG. 5 implies the presence of the inner threads. In particular, arrow 504 shows tightening the backward open end 907A against the forward end 105A of the vacuum adaptor 104 by rotation, as shown in FIG. 5.

The side wall 903 may also include a second unthreaded portion 906 connected to the first unthreaded portion 910 by a transition portion 908, which is configured for adapting the seal ring 114. The second unthreaded outer portion 906 may have an outer diameter slightly larger than that of the outer diameter of the first unthreaded portion 910.

It will be appreciated by those skilled in the art that the shape and size of the grooves and the number of the grooves may vary to adjust the airflow.

It will also be appreciated by those skilled in the art that the diameter of the inner wall may vary with the size of the screws.

In some variations, the vacuum nozzle may be made of a plastic.

Example dimensions for the vacuum nozzle 102 are given below. The vacuum nozzle 102 had a cylindrical length of approximately 1.25 inches and a diameter of the outer wall surface of approximately 0.31 inches. The groove 902 had a diameter of approximately 0.028 inches. The unthreaded portion 910 of the vacuum nozzle 102 had a depth of approximately 0.83 inches. It will be appreciated by those skilled in the art that the dimensions may vary with the driver bit and/or the vacuum adaptor, etc.

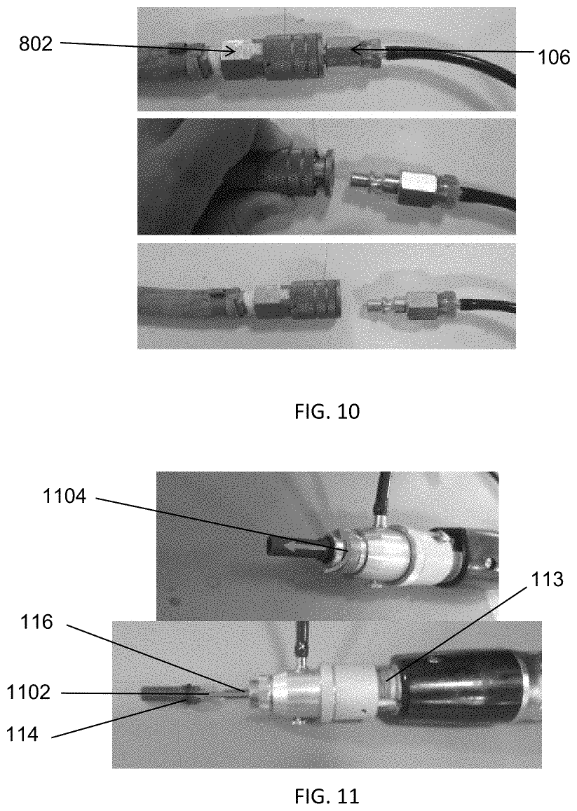

FIG. 10 illustrates an operation to disconnect the vacuum adaptor from the main vacuum line in according to embodiments of the disclosure. As shown, the vacuum line 106 of the vacuum adaptor 104 is disconnected from the main vacuum line 802. Note that the vacuum line 106 is in a fluidic communication with the main vacuum line 802 when assembled or connected together. The vacuum line 106 and the main vacuum line 802 are sealed for sucking air through the lines by a vacuum source or vacuum pump.

FIG. 11 illustrates an operation to remove the vacuum nozzle from the vacuum adaptor in according to embodiments of the disclosure. As shown, the vacuum nozzle 102 is untightened by rotation as pointed by arrow 1104 and then removed from the vacuum adaptor 104 along a longitudinal direction as pointed by arrow 1102. Note that seal ring 114 is removed from the vacuum adaptor 104 along with the vacuum nozzle 102. After the removal of the vacuum nozzle 102, the driver bit 116 can be seen.

When the nozzle assembly 100 is in operation to drive a screw with the driver bit 116, a vacuum is established within the vacuum nozzle 102 when communicating with a vacuum source or a vacuum pump operable to suck air through the vacuum nozzle 102. The vacuum within the vacuum nozzle 102 can help hold the screw and washers and/or lock washers as the driver bit 116 advances the screw to drill the screw into a workpiece. The vacuum nozzle 102 enhances airflow to the vacuum source around the screw and helps provide sufficient vacuum to hold the screw and additional hardware simultaneously, such as washers and/or lock washers.

In some embodiments, the screws or fasteners may be non-magnetic.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the invention. Accordingly, the above description should not be taken as limiting the scope of the invention. Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

What is claimed:

1. A vacuum nozzle comprising:
a side wall enclosing a cavity extending along a longitudinal axis from a first open end to a second open end opposite to the first open end; and
a plurality of interior grooves extending from an inner surface of the side wall into the side wall toward an outer surface of the side wall, the plurality of interior grooves extend along the longitudinal axis.

2. The vacuum nozzle of claim 1, wherein the vacuum nozzle comprises a plastic.

3. The vacuum nozzle assembly of claim 1, wherein the outer wall surface has a first diameter and the inner wall surface has a second diameter.

4. The vacuum nozzle assembly of claim 3, wherein the plurality of interior grooves has a depth less than the difference between the first and second diameters.

5. The vacuum nozzle assembly of claim 1, wherein the plurality of interior grooves are spaced apart circumferentially on a cross-section perpendicular to the longitudinal axis.

6. A vacuum nozzle assembly comprising:
a driver bit having a main body between a base end and a tip end configured to drive a screw and the main body extending along a longitudinal axis;
a vacuum adaptor comprising a forward end, a backward end, and an outer shell enclosing a hollow portion and extending along the longitudinal axis; and
a vacuum nozzle comprising a side wall enclosing a cavity extending along the longitudinal axis from a forward open end to a backward open end opposite to the forward open end and being coaxial with the driver bit and the vacuum adaptor, the backward open end configured to attach to the forward end of the vacuum adaptor.

7. The vacuum nozzle assembly of claim 6, wherein the hollow portion of the vacuum adaptor is configured to allow the driver bit to extend through.

8. The vacuum nozzle assembly of claim 6, wherein the cavity of the vacuum nozzle is configured to allow the driver bit to extend from the backward open end through the forward open end.

9. The vacuum nozzle assembly of claim 6, wherein the vacuum adaptor comprises a lock screw positioned on the outer shell to fix the position of the forward end of the vacuum adaptor along the longitudinal axis of the vacuum adaptor relative to the outer shell of the vacuum adaptor.

10. The vacuum nozzle assembly of claim 6, wherein the vacuum nozzle has a cylindrical tube shape.

11. The vacuum nozzle assembly of claim 6, wherein the backward open end of the vacuum nozzle comprises a plurality of outer threads configured to attach to a plurality of inner threads of the forward end of the vacuum adaptor.

12. The vacuum nozzle assembly of claim 6, wherein the vacuum adaptor comprises a vacuum line connection on the outer shell and configured to connect to a vacuum source.

13. The vacuum nozzle assembly of claim 6, further comprising a sealing ring on the outer wall of the vacuum nozzle.

14. The vacuum nozzle assembly of claim 1, wherein the side wall of the vacuum nozzle has an outer wall surface and an inner wall surface, wherein the vacuum nozzle has a plurality of interior grooves extending from the inner surface of the side wall into the side wall toward the outer surface.

15. An assembly device comprising:
a driver base;
a driver bit having a main body between a base end and a tip end configured to drive a screw and the main body extending along a longitudinal axis, the driver bit configured to attach to the driver base;
a vacuum adaptor comprising a forward end, a backward end, and an outer shell enclosing a hollow portion and extending along the longitudinal axis, the backward end configured to attach to the driver base; and
a vacuum nozzle comprising a side wall enclosing a cavity extending along the longitudinal axis from a forward open end to a backward open end opposite to the forward open end and being coaxial with the driver bit and the vacuum adaptor, the backward open end configured to attach to the forward end of the vacuum adaptor.

16. The assembly device of claim 15, wherein the driver base comprises a bit collect configured to hold the base end of the driver bit.

17. The assembly device of claim 15, further comprising a torque nut configured to attach to outer threads of the driver base.

18. The assembly device of claim 17, wherein the torque nut is configured to attach to the backward end of the vacuum adaptor.

19. A method of using the assembly device of claim 15 for holding screws and additional hardware including washers and/or lock washers.

20. The method of claim 19, wherein the vacuum nozzle enhances airflow to the vacuum source around the screws and helps provide sufficient vacuum to simultaneously hold the additional hardware including washers and/or lock washers with the screws.
